(19) United States
(12) Patent Application Publication
(10) Pub. No.: US 2025/0380094 A1
(43) Pub. Date: Dec. 11, 2025

(54) HEARING INSTRUMENT AND METHOD FOR NOISE SUPPRESSION IN A HEARING INSTRUMENT

(71) Applicant: Sivantos Pte. Ltd., Singapore (SG)

(72) Inventors: Tobias Daniel ROSENKRANZ, Erlangen (DE); Michael MÜLLER, Erlangen (DE)

(21) Appl. No.: 19/233,115

(22) Filed: Jun. 10, 2025

(30) Foreign Application Priority Data
Jun. 10, 2024 (DE) 10 2024 205 358.9

(51) Int. Cl. H04R 25/00

(52) U.S. Cl. CPC H04R 25/507; H04R 25/43; H04R 2225/43; H04R 2460/01

(57) ABSTRACT

A method for noise suppression in a hearing instrument includes using an acousto-electric input transducer of the hearing instrument to generate an input signal from ambient sound. A frequency-band-wise noise suppression is applied to a processing signal derived from the input signal. Stationary noise is detected in the respective frequency band, and depending on the detected stationary noise, an amplification factor of the processing signal is set for the relevant frequency band. An analysis adapted to detect stationary and non-stationary noise is applied to the processing signal. The analysis has a lower frequency resolution than the frequency-band-wise noise suppression and, upon detected presence of stationary and/or non-stationary noise in the analysis of the processing signal, the stationary noise in the frequency-band-wise noise suppression is presumed to be detected in each frequency band, and the corresponding amplification factors are set.

### CROSS-REFERENCE TO RELATED APPLICATION

This application claims the priority, under 35 U.S.C. § 119, of German Patent Application DE 10 2024 205 358.9, filed Jun. 10, 2024; the prior application is herewith incorporated by reference in its entirety.

### FIELD AND BACKGROUND OF THE INVENTION

The invention relates to a method for noise suppression in a hearing instrument, wherein a frequency-band-wise noise suppression is applied to a processing signal derived from an input signal of the hearing instrument, in which stationary noise is detected in the respective frequency band. The invention also relates to a hearing instrument.

The term “hearing instrument” is usually understood to mean devices which serve to output audio signals to the auditory system or, more generally, to the auditory cortex of a user of the corresponding device. In particular, hearing aids are encompassed by this term. Hearing aids are used by persons with a hearing impairment to at least partially compensate for hearing loss resulting from this hearing impairment. For this purpose, hearing aids usually have at least one electroacoustic input transducer, most commonly in the form of a microphone, for detecting acoustic (ambient) sound and converting it into an electric input signal. Moreover, such hearing aids regularly have a signal processing apparatus adapted to analyze the input signal(s) for spurious components (e.g., noise, a loud environment and the like), to filter and/or attenuate these spurious components and to amplify the remaining signal components as a useful signal (such as, in particular, speech and/or music).

In order to output the input signal processed in this way to the auditory system, hearing aids most commonly include an electroacoustic output transducer, e.g., in the form of a loudspeaker (also referred to as an earphone or a “receiver”), through the use of which the processed input signal is converted into an output sound signal and is output to the auditory system of the wearer of the hearing aid. Alternatively, hearing aids have a cochlear or bone conduction earphone for outputting an output signal in electric or mechanical form to the auditory system.

The signal processing in the hearing instrument may vary, in part drastically, as a function of the general acoustic ambient situation. Individual sub-processes of the signal processing, such as, e.g., detection of a speech activity (in particular the user's own speech activity) or a noise suppression, may become complex to different extents as a function of the acoustic ambient situation and, in this respect, require different resources to provide adequate parameters of signal processing (such as frequency-band-dependent amplification factors for noise suppression) with a sufficiently high degree of certainty. The quality of the applied signal processing depends significantly on the “quality” of the signal analysis, that is, on the precision of its detection. Since noise suppression in particular is a process which is performed in many situations in addition to other signal processing algorithms, an implementation in the most resource-efficient way possible is desired.

### SUMMARY OF THE INVENTION

It is accordingly an object of the invention to provide a hearing instrument and a method for noise suppression in a hearing instrument, which overcome the hereinafore-mentioned disadvantages of the heretofore-known methods and instruments of this general type and which allow the simplest possible and at the same time precise noise suppression for signal processing of a hearing instrument.

With the foregoing and other objects in view there is provided, in accordance with the invention, a method for noise suppression in a hearing instrument, wherein an acousto-electric input transducer of the hearing instrument generates an input signal from an ambient sound, a frequency-band-wise noise suppression is applied to a processing signal derived from the input signal, in which stationary noise is detected in the respective frequency band, and depending on the detected stationary noise, an amplification factor of the processing signal is set for the relevant frequency band.

According to the method, it is provided that an analysis which is adapted to detect both stationary and non-stationary noise is applied to the processing signal, wherein the analysis has a lower frequency resolution than the frequency-band-wise noise suppression, and in the case of detected presence of stationary and/or non-stationary noise in the analysis of the processing signal, the stationary noise in the frequency-band-wise noise suppression is presumed to be detected in each frequency band, and the corresponding amplification factors are set, and preferably, an output signal is generated from the processing signal which has been amplified band by band with the amplification factors. Advantageous embodiments, some of which are inventive in themselves, are the subject of the dependent claims and of the following description.

A hearing instrument generally encompasses any device which is adapted to generate a sound signal from an electric signal—which may also be given by an internal signal of the device—and to supply it to an auditory system of a wearer of this device, that is, in particular, to a headphone (e.g., as an “earbud”), a headset, data glasses with a loudspeaker, etc. A hearing instrument, however, also encompasses a hearing aid in the narrower sense, that is, a device for treating a hearing impairment of the wearer, in which an input signal generated from an ambient signal by a microphone is processed into an output signal and, in particular, is amplified in a frequency-band-dependent manner, and an output sound signal generated from the output signal by a loudspeaker or the like is suitable to at least partially compensate the hearing impairment of the wearer, in particular in a user-specific manner.

In particular, an acousto-electric input transducer encompasses any device which is adapted to generate a corresponding electric signal from a sound signal. In particular, during the generation of the first or second input signals by the respective input transducer, preprocessing, e.g., in the form of linear preamplification and/or A/D conversion, may also take place. The correspondingly generated input signal is given in particular by an electric signal having current and/or voltage fluctuations which basically represent the sound pressure fluctuations of the air.

A processing signal derived from the input signal is understood to mean, in particular, that signal components of the input signal are included in the processing signal, wherein the processing signal may, as appropriate, also contain signal components of other signals (such as of a further input signal in the case of directional processing of the input signals), and wherein the signal components of the input signal may be amplified, in particular in a frequency-dependent manner, or band limiting (that is, a complete suppression of certain frequency bands) of the input signal may also take place, as appropriate. However, the signal components of the input signal may in particular also be included in the processing signal completely and/or unaltered. In particular, the processing signal may thus also be given directly by the (complete and unaltered) input signal.

Frequency-band-wise noise suppression is understood to mean, in particular, that the processing signal is divided into a plurality of frequency bands in a suitable fashion, that is, for example, preferably through the use of an analysis filter bank (wherein, in particular, adjacent frequency bands may have a finite overlap at their respective band edges), and the signal components of the individual frequency bands are suppressed as the described function of the respective stationary noise in the relevant frequency band by applying a corresponding amplification factor for the signal components of the processing signal in the frequency band a priori to lower or raise the same relative to one another as the function.

Stationary noise encompasses, in particular, noise which, on a time scale of at least 0.5 s, preferably at least 1 s, more preferably at least 2 s, has level variations of less than 5 dB, preferably less than 3 dB, in the respective frequency band. In particular, any signal components which meet the required conditions for stationarity (that is, do not exceed a maximum variation of the signal level over the minimum period described) may be regarded as noise. This happens in particular under the assumption that useful signals are most commonly speech signals or even music, each having a higher variation of the signal level within a frequency band.

An analysis which is adapted to detect both stationary and non-stationary noise is understood to mean, in particular, that the processing signal, in particular in an analysis path parallel to the frequency-band-wise noise suppression, is examined for noise on the basis of (in particular temporal) features of the signal components, the information content of which preferably goes beyond the examination of the variation of signal levels. This analysis has a lower frequency resolution than the frequency-band-dependent noise suppression and may in particular make a wideband statement about the presence of stationary and/or non-stationary noise (i.e., a statement about whether any form of noise is present anywhere in the processing signal, regardless of frequency range). In the case where such a statement is made separately by the analysis according to individual frequency ranges, these are each larger, and preferably significantly larger, than the respective bandwidths of the frequency-dependent noise suppression (that is, preferably at least twice as large, more preferably on average at least four times as large). Hereby, it may be ensured in particular that the analysis has a lower latency than the frequency-dependent noise suppression and may thus be employed in the described fashion for its control.

In particular, the cited analysis of the processing signal may take place by using an artificial neural network (ANN), wherein signal strings and/or analysis features with respect to time are generated from the processing signal, which are relayed to the ANN as input variables for analysis. The signal strings may be provided in particular by short fragments of the processing signal, for example, with a length of >1 ms, preferably >5 ms, more preferably >30 ms. The analysis features may be given, in particular, by temporal and/or spectral features of the processing signal, that is, for example, by modulation properties (such as the modulation depth at 4 Hz, or a center-of-gravity frequency as well as its change, etc.).

However, the analysis of the processing signal may also take place, for example, by using a set of wavelets, wherein a correlation with signal components (in particular the signal strings) of the processing signal is ascertained for each of them, so that, from the different correlations with the wavelets, any non-stationary noise is also detected in the processing signal, as appropriate. The analysis may also take place on the basis of speech detection, so that general (that is, stationary and/or non-stationary) noise is present if no speech is detected (and vice versa).

That is, if noise is detected in the analysis of the processing signal-regardless of whether it is stationary or non-stationary-, then in the frequency-band-wise noise suppression, the stationary noise is deemed to be detected in each frequency band, and the associated amplification factor for the frequency band is respectively set. The frequency-band-wise noise suppression therefore checks for a criterion in each frequency band as to whether any stationary noise is present in the frequency band, and thus the noise suppression (via the associated amplification factor) is applied, while the analysis checks for a different criterion, namely whether any noise of any kind (stationary or not) is present, and in the corresponding case, there is an intervention in the detection of the stationary noise of the frequency-band-wise noise suppression, so that stationary noise is considered to be detected in all frequency bands.

In other words, the analysis of the processing signal is thus used here as an additional trigger or activator of the frequency-band-wise noise suppression, wherein the actual suppression of the noise continues (at least also) to take place via its frequency-band-wise amplification factors. The analysis of the processing signal here only intervenes in the trigger or activator of the frequency-band-wise noise suppression by setting the trigger or activator (namely the stationary noise) as detected for all frequency bands and, as a result, setting the corresponding amplification factors in the frequency bands to be applied to the processing signal.

An clear application of (stationary or non-stationary) noise detected by the analysis of the processing signal as a trigger/activator of the frequency-band-wise noise suppression would be to simply multiply an additional activation factor by the individual amplification factors as a function of the analysis. However, in the case of a so-called “speech onset” (that is, an onset of speech), the analysis would no longer detect any noise under normal circumstances (and with usual parametrization). In this case, however, the attenuation would be abruptly withdrawn in those frequency bands in which non-stationary noise (with variations in a time scale of, for example, about 1 s, such as several short “noise bursts” due to loud traffic or a machine or the like) continues to be present since in these, the frequency-band-wise noise suppression has not set any corresponding amplification factor for noise suppression since the frequency-band-wise noise suppression, in fact, reacts only to stationary noise. These noise components would be “comodulated” (that is, effectively admixed) directly with the output signal generated from the noise-suppressed processing signal, which would be clearly perceptible and is therefore undesirable.

The present invention therefore chooses a different way of integrating the trigger/activator from the analysis of the processing signal with respect to general noise into the frequency-band-wise noise suppression. Namely, instead of taking the application of the amplification factors into account, there is an intervention in the frequency-band-wise detection of the (stationary) noise, and the stationary noise is set to be present for each of the frequency bands so that the corresponding amplification factor for suppressing (stationary) noise may be set in each frequency band and may be applied to the signal components of the processing signal. In the above-mentioned situation of a speech onset (which, in fact, represents a temporary, short absence of noise), nothing would change for frequency bands with stationary noise (since for them, in fact, the stationary noise is still detected and is correspondingly suppressed via the associated amplification factor). In frequency bands without stationary noise, however, the noise suppression may be omitted upon a speech onset (and thus the speech components may be preserved) if, in the case of a detected speech onset, the noise suppression is operated solely on the basis of the detected stationary noise. Hereby, the described comodulation of the stationary noise may be prohibited.

Preferably, from the input signal, an onset of speech is detected in the ambient sound (that is, by using a so-called “voice activity detection” applied to the input signal, the processing signal or any other signal derived from the input signal), and in this case, the frequency-band-wise noise suppression sets the amplification factor of the processing signal in each frequency band depending on the respectively detected stationary noise. In particular, for the detected onset of speech (that is, upon detecting a speech onset), the mode of functioning of the frequency-band-wise noise suppression may be reset to the state which was valid before detecting the general (stationary and/or non-stationary) noise by using the analysis of the processing signal.

Preferably, from the processing signal having the described noise suppression (and in particular the frequency-band-dependent amplification factors set according to the above-mentioned criteria) applied thereto, an output signal of the hearing instrument is generated which is converted into an output sound signal by an (electro-acoustic) output transducer of the hearing instrument, wherein more preferably, voltage and/or current fluctuations in the output signal are transformed into corresponding amplitude fluctuations of the output signal. The output transducer may in particular be given as a loudspeaker, which is known as a balanced metal case receiver, but also as a bone conduction earphone.

Favorably, for the frequency-band-wise noise suppression, the stationary noise is detected in the respective frequency band from a first level measurement and from a second level measurement. That is, in each frequency band, two different level measurements with preferably different time constants in at least one edge (rising or falling) are applied to the signal components of the processing signal, and stationary noise in the frequency band is detected there from the two level measurements cited, in particular from a difference and/or a quotient of the two level measurements. The use of two level measurements has the advantage that level measurements may intrinsically carry the information on the stationarity of the signal level by using suitable selection of a release constant.

Appropriately, the first level measurement is parameterized such that it has a short first adjustment time and a long first decay time, and the second level measurement is parameterized such that it has a long second adjustment time and a long second decay time, wherein the first decay time and the second decay time are preferably identical, wherein the stationary noise is detected from the difference or from a quotient of the first level measurement and the second level measurement, and the amplification factor for the processing signal is preferably set depending on the difference. In other words, the first level measurement reacts quickly to short-term level changes in the frequency band and may therefore function as a so-called “peak tracker,” whereas the second level measurement reacts more slowly to alterations in the signal level than the first level measurement. However, the decay time is long and preferably identical for both level measurements so that the level measurements gradually converge to one another during their exponential decay behavior for stationary signal levels.

Also, favorably, the amplification factor of the processing signal for the relevant frequency band is set as a monotonic function of the difference of the first level measurement and the second level measurement. This means in particular that, the greater the difference of the two level measurements (and thus the greater the influence of a peak which is included in the first level measurement more quickly than in the second), the higher the resulting amplification of the processing signal, and that, the smaller the difference of the two level measurements (and thus an increasingly stationary signal level is present in the frequency band), the lower the resulting amplification of the processing signal or the higher its attenuation.

Advantageously, in the case of detected presence of stationary and/or non-stationary noise, the stationary noise in the frequency-band-wise noise suppression is presumed to be detected in each frequency band by altering the respective values of the first adjustment and decay times towards the respective values of the second adjustment and decay times, and in particular by equating them, so that the difference of the level measurements decreases, preferentially at least halves, and in particular disappears. In particular, the short first adjustment time of the first level measurement is set to the higher value of the second adjustment time of the second level measurement.

It further proves advantageous if the analysis of the processing signal detects presence or absence of speech and, in the case of detected absence of speech, stationary or non-stationary noise is assumed to be detected. This includes, in particular, that the analysis only knows two distinct results, namely the presence of speech, which is equated with an absence of noise of any kind, and the absence of speech, which is equated with a presence of general noise. The detection of, in particular non-stationary, noise from a detection of speech is particularly advantageous since algorithms for speech detection are very advanced and, in particular, may also be performed with sufficient precision by a signal, in particular a wideband signal.

More preferably, in the case of a detected onset of speech, in the input signal and/or in the processing signal, at least the values of the first and second adjustment times are altered away from one another, and in doing so, in particular, the original values of the first and second adjustment and decay times, which were valid before detecting the presence of stationary and/or non-stationary noise through the use of the analysis of the processing signal, are respectively restored. In other words, speech detection/VAD may be applied to the input signal and/or the processing signal, and thus it may also be detected that speech is suddenly present in the ambient sound. In this case, the values of the adjustment times are altered such that their difference increases. In particular, the original values which were valid before detecting the speech present may be restored for the two adjustment times and also for the two decay times. The onset of speech may also be detected in particular in the analysis of the processing signal.

The described procedure makes it possible for the frequency-band-wise noise suppression to continue to operate normally again when an onset of speech is detected, and thus for stationary noise to be suppressed in the relevant frequency bands, whereas in the frequency bands with speech components, these are no longer suppressed.

In a further advantageous embodiment, the analysis takes places through the use of an ANN, wherein an output class of the ANN is the presence of stationary and/or non-stationary noise. An ANN is particularly suitable for performing the analysis, in particular in the case of a simplification of the output classes as described.

Preferentially, from the input signal or from the processing signal, a plurality of acoustic features are formed, which are used as input variables of the artificial neural network, wherein the acoustic features are taken from the following set: center-of-gravity frequency of an overall signal and/or of a noise background, modulation depth with at least one given modulation frequency, stationarity, signal level, noise level for at least one given frequency range, autocorrelation value for at least one given time delay. These features are highly conclusive with respect to the presence of noise and may also be ascertained for a signal in a simple fashion without leading to a substantially increased signal delay.

With the objects of the invention in view, there is concomitantly provided a hearing instrument, including an acousto-electric input transducer for generating an input signal from an ambient sound, and a signal processing apparatus, wherein the hearing instrument is adapted to perform the method described above. Preferably, the signal processing apparatus is equipped with corresponding signal processors and/or ASICs to implement the individual method steps of the signal processing.

The hearing instrument according to the invention shares the benefits of the method according to the invention. The advantages indicated for the method and for its developments may be transferred to the hearing instrument analogously.

The hearing instrument preferably has measures for implementing an ANN (for example, corresponding signal processors and/or ASICs). The analysis of the processing signal for detecting stationary and/or non-stationary noise may be implemented particularly effectively by using an ANN and at the same time as true as possible in terms of transit time.

Other features which are considered as characteristic for the invention are set forth in the appended claims.

Although the invention is illustrated and described herein as embodied in a hearing instrument and a method for noise suppression in a hearing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block circuit diagram of a hearing instrument; and

FIG. 2 shows a block diagram of a method for noise suppression for the hearing instrument of FIG. 1.

### DETAILED DESCRIPTION OF THE INVENTION

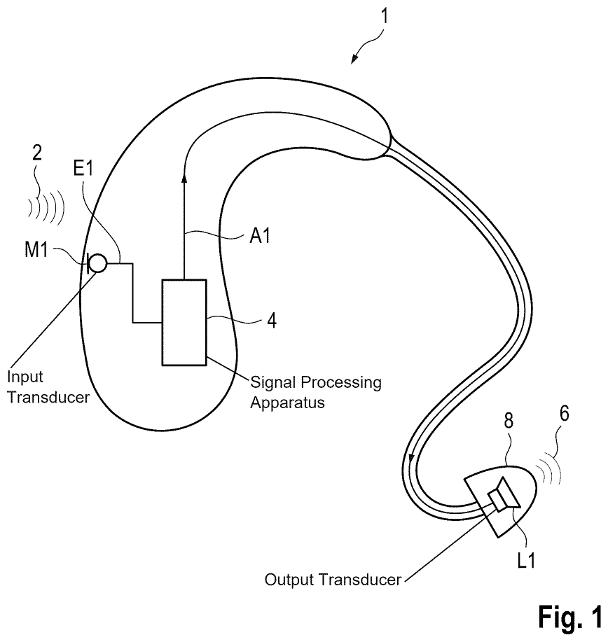

Referring now in detail to the figures of the drawings, in which corresponding parts and variables are each labelled with the same reference numerals, and first, particularly, to FIG. 1 thereof, there is seen a schematic block circuit diagram of a hearing instrument 1 having an input transducer M1. The input transducer M1 is given by a corresponding microphone. The input transducer M1 is adapted to generate an input signal E1 from an ambient sound 2 during operation of the hearing instrument 1. The hearing instrument 1 may also have a further input transducer (not depicted in FIG. 1), which is adapted to generate a further input signal from the ambient sound 2 during operation of the hearing instrument 1. The first input signal E1 (and the further input signal, if applicable) is supplied to a signal processing apparatus 4, in which the input signal E1 (and the further input signal, if applicable) is processed into an output signal A1, and in particular is amplified and/or compressed in a frequency-band-wise manner. The signal processing of the input signal and of the further input signal into the output signal A1 may take place in particular in a direction-dependent manner, i.e., contributions of individual sound sources from different spatial directions may be amplified to different extents in the ambient sound. Furthermore, the signal processing may in particular take place according to the audiological requirements of a wearer of the hearing instrument 1.

The hearing instrument 1 further has an output transducer L1 which is adapted to generate an output sound signal 6 from the output signal A1. The schematic depiction of the hearing instrument 1 in FIG. 1 shows a so-called a behind-the-ear (BTE) hearing aid with an earpiece 8 in which the output transducer L1 is disposed, however, the hearing instrument 1 is also conceivable as a structural form, in particular as an in-the-ear (ITE) hearing aid, an in-the-canal (ITC) hearing aid, a completely-in-the-canal (CIC) hearing aid, a receiver-in-the-canal (RIC) hearing aid, or in particular also as an earphone which is not exclusively or not primarily provided for treating a hearing impairment.

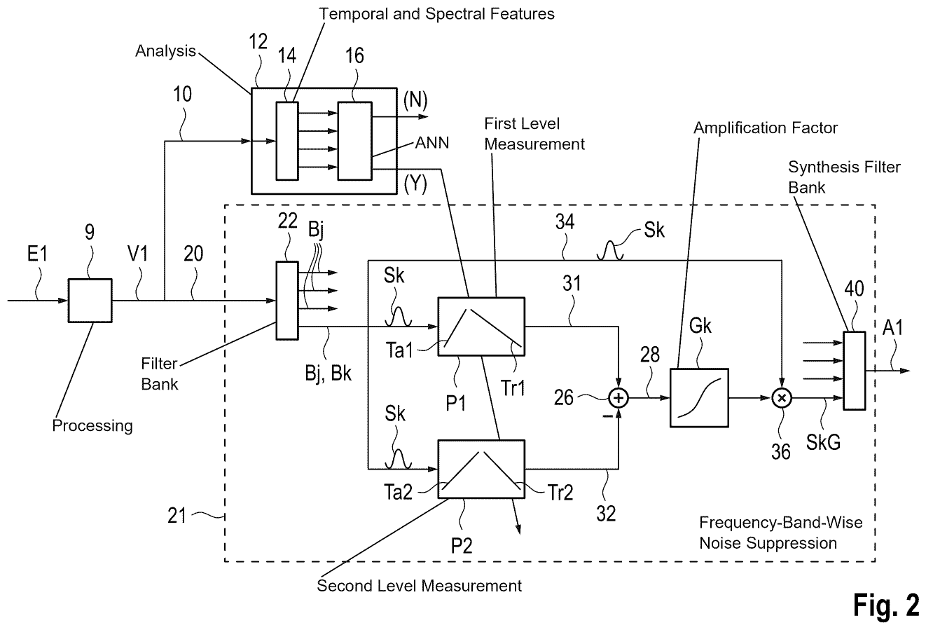

FIG. 2 schematically depicts a block diagram of the sequence of a method for noise suppression in the hearing instrument 1 of FIG. 1. A processing signal V1 is first derived from the input signal E1 through the use of preprocessing 9 not depicted in more detail (which may in particular include downsampling or the like, but also band limiting). In the present case, however, the processing signal V1 may also be identical to the input signal E1. In particular, in the case of a further input signal (not depicted in FIG. 1 and FIG. 2), the processing signal V1 may be derived from both input signals.

The processing signal V1, which is a wideband signal in the present case, is now subjected to an analysis 12 in an analysis path 10 as to whether any general (that is, stationary and/or non-stationary) noise is present in the processing signal. In order to achieve this, various temporal and spectral features 14 are ascertained from the processing signal V1. The features 14 may in particular be gathered from the following (non-exhaustive) group: center-of-gravity frequency of an overall signal and/or of a noise background, modulation depth with at least one given modulation frequency, signal level, noise level, autocorrelation value for at least one given time delay. The features 14 are then relayed as input variables to an ANN 16, which is trained to detect a presence Y or an absence N of general noise from the features 14. In particular, the ANN 16 may also detect an absence or presence of speech and detect general noise therefrom, i.e., an absence of speech means a presence (Y) of stationary and/or non-stationary noise (the reverse conclusion need not necessarily be given here, however, the absence of general noise may also be detected from further parameters/features).

Also, a frequency-band-wise noise suppression 21 is applied to the processing signal V1 in a processing path 20. In order to achieve this, the processing signal V1 is divided into a plurality of frequency bands Bj by using a filter bank 22. In each of the frequency bands Bj, a first level measurement P1 and a second level measurement P2 are now applied to the signal components Sk of the processing signal V1 there, wherein the first level measurement P1 takes place with a short first adjustment time Ta1 and a first decay time Tr1, and the second level measurement P2 takes place with a long second adjustment time Ta2>Ta1 and a second decay time Tr2=Tr1 which is preferentially identical to the first decay time Tr1. For reasons of clarity, this is depicted in FIG. 2 solely for the frequency band Bk by way of example (but takes place for all frequency bands Bj). In principle and independently of the present exemplary embodiment, the two level measurements may be implemented, in particular, via recursive first-order low-pass filters with different time constants for the respectively rising or respectively falling edge.

The result 32 of the second level measurement P2 is now subtracted from the result 31 of the first level measurement P1 at a node 26, and the difference 28 for the frequency band Bk is monotonically mapped to an amplification factor Gk for noise suppression for the frequency band Bk. At a node 36, the amplification factor Gk is subsequently multiplied by the signal components Sk of the processing signal V1 in the frequency band Bk, for which purpose these are additionally directed past the two level measurements P1, P2 in a bypass 34.

The signal components SkG of the processing signal V1 thus amplified with the respective amplification factors Gk are then combined at a synthesis filter bank 40, and the output signal A1 is generated therefrom, (any further signal processing of the signal resulting from the synthesis filter bank 40 into the output signal A1 is to be neglected in this case, but may be solved by defining a preliminary output signal as the resulting signal).

Due to the different adjustment times Ta1<Ta2 of the level measurements P1, P2, the difference 28 of the results 31, 32 reacts to stationary noise in the respective frequency band Bj, i.e., if the signal component Sk is more stationary, then the results 31, 32 of the two level measurements P1, P2 converge in an exponentially falling manner with respect to one another, which is why the difference 28 becomes smaller and smaller. This stationary signal component Sk is then deemed to be noise, which is why the difference 28 is monotonically mapped to the respective amplification factor (here Gk): as the difference 28 decreases (that is, as stationarity increases), the amplification factor Gk becomes smaller, and the amplified signal component SkG is suppressed further and further. However, in the case of a short peak (that is, the factual opposite of a stationary signal component Sk), as a result of the different adjustment times Ta1<Ta2, the results 31, 32 of the level measurements P1 and P2 initially diverge abruptly so that their difference 28 grows as well. Correspondingly, the amplification factor Gk also rises so that the amplified signal components SkG are raised.

If the presence Y of stationary and/or non-stationary noise is now detected by the analysis 12 of the wideband processing signal V1 in the analysis path 10, the result is that in the processing path 20, in all the first level measurements P1 (that is, in the first level measurement P1 of each frequency band Bj), the first adjustment time Ta1 is increased to the second adjustment time Ta2 of the respective second level measurement P2 (that is, Ta1=>Ta2), and this preferentially applies at least as long as the presence Y is detected in the analysis 12.

Thereby, noise, indeed also including non-stationary noise (which would otherwise not be detectable from the two level measurements P1, P2), may now be detected in all frequency bands Bj and suppressed via the associated amplification factors (Gk). Further, if a sudden presence of speech is detected in the analysis 12, the original values of the two adjustment times Ta1<Ta2 may be restored so that the frequency-band-wise noise suppression 21 only actually acts in those frequency bands Bj, Bk in which it detects (and thus suppresses) stationary noise, whereby the speech components in the other frequency bands Bj, Bk without stationary noise are preserved. It is thus assumed that, in addition to the speech components, there are no further non-stationary signal components and there is in particular no non-stationary noise to a considerable extent.

Although the invention has been illustrated and described in more detail by the preferred exemplary embodiment, the invention is not restricted by the disclosed examples and other variations may be derived from them by a person skilled in the art without departing from the scope of protection of the invention.

The following is a summary list of reference numerals and the corresponding structure used in the above description of the invention:
1 Hearing instrument
2 Ambient sound
4 Signal processing apparatus
6 Output sound signal
8 Earpiece
9 Preprocessing
10 Analysis path
12 Analysis
14 Features
16 ANN
20 Processing path
21 Frequency-band-wise noise suppression
22 Filter bank
26 Node
28 Difference
31 Result (of first level measurement)
32 Result (of second level measurement)
34 Bypass
36 Node
40 Synthesis filter bank
A1 Output signal
Bj, Bk Frequency bands
E1 Input signal
Gk Amplification factor
L1 Output transducer
M1 Input transducer
N Absence of general noise
P1/2 First/second level measurement
Sk Signal components (of processing signal) in frequency band
SkG Amplified signal components
Ta1/2 First/second adjustment time
Tr1/2 First/second decay time
V1 Processing signal
Y Presence of general noise

1. A method for noise suppression in a hearing instrument, the method comprising:
using an acousto-electric input transducer of the hearing instrument to generate an input signal from an ambient sound;
applying a frequency-band-wise noise suppression to a processing signal derived from the input signal, including:
detecting stationary noise in a respective frequency band, and
depending on the detected stationary noise, setting an amplification factor of the processing signal for a relevant frequency band;
applying an analysis adapted to detect both stationary and non-stationary noise to the processing signal, and providing the analysis with a lower frequency resolution than the frequency-band-wise noise suppression; and
upon a detected presence of at least one of stationary or non-stationary noise in the analysis of the processing signal, presuming the stationary noise in the frequency-band-wise noise suppression to be detected in each frequency band, and setting corresponding amplification factors.

2. The method according to claim 1, which further comprises detecting an onset of speech in the ambient sound from the input signal, and using the frequency-band-wise noise suppression to set the amplification factor of the processing signal in each frequency band depending on the respectively detected stationary noise.

3. The method according to claim 1, which further comprises carrying out the frequency-band-wise noise suppression by detecting the stationary noise in the respective frequency band from a first level measurement and from a second level measurement.

4. The method according to claim 3, which further comprises:
parameterizing the first level measurement to provide the first level measurement with a relatively short first adjustment time and a relatively long first decay time;
parameterizing the second level measurement to provide the second level measurement with a relatively long second adjustment time and a relatively long second decay time; and
detecting the stationary noise from a difference between the first level measurement and the second level measurement.

5. The method according to claim 4, which further comprises setting the amplification factor of the processing signal for the relevant frequency band as a monotonic function of the difference between the first level measurement and the second level measurement.

6. The method according to claim 4, which further comprises, upon detecting the presence of at least one of stationary or non-stationary noise, presuming the stationary noise in the frequency-band-wise noise suppression to be detected in each frequency band by altering respective values of the first adjustment and decay times towards respective values of the second adjustment and decay times.

7. The method according to claim 6, which further comprises equating the respective values of the first and second adjustment and decay times.

8. The method according to claim 1, which further comprises using the analysis of the processing signal to detect a presence or an absence of speech and, upon a detected absence of speech, assuming stationary or non-stationary noise to be detected.

9. The method according to claim 6, which further comprises, upon a detected onset of speech in at least one of the input signal or the processing signal, respectively altering the values of the first and second adjustment and decay times away from one another.

10. The method according to claim 9, which further comprises, upon a detected onset of speech, respectively restoring original values of the first and second adjustment and decay times before detecting the presence of at least one of stationary or non-stationary noise.

11. The method according to claim 1, which further comprises carrying out the analysis of the processing signal for detecting both stationary and non-stationary noise in a wideband manner.

12. The method according to claim 1, which further comprises:
using an artificial neural network to carry out the analysis of the processing signal; and
using the presence of at least one of stationary or non-stationary noise as an output class of the artificial neural network.

13. The method according to claim 12, which further comprises:
forming a plurality of acoustic features from the input signal, and using the plurality of acoustic features as input variables of the artificial neural network; and
taking the acoustic features from a following set: center-of-gravity frequency of at least one of an overall signal or a noise background, modulation depth with at least one given modulation frequency, stationarity, signal level, noise level for at least one given frequency range, autocorrelation value for at least one given time delay.

14. A hearing instrument, comprising:
an acousto-electric input transducer for generating an input signal from an ambient sound; and
a signal processing apparatus;
the hearing instrument being adapted to perform the method according to claim 1.

15. The hearing instrument according to claim 9, which further comprises a device for implementing an artificial neural network.
